(19) United States
(12) Patent Application Publication
(10) Pub. No.: US 2022/0417957 A1
(43) Pub. Date: Dec. 29, 2022

(54) MULTI-RECEIVER SCHEDULING USING SUB-SLOT BASED PHYSICAL SIDELINK SHARED CHANNELS

(71) Applicant: QUALCOMM INCORPORATED, San Diego, CA (US)

(72) Inventors: Chih-Hao LIU, San Diego, CA (US); Yisheng XUE, San Diego, CA (US); Jing SUN, San Diego, CA (US); Xiaojie WANG, Hillsborough, NJ (US); Xiaoxia ZHANG, San Diego, CA (US); Sony AKKARAKARAN, Poway, CA (US); Piyush GUPTA, Bridgewater, NJ (US); Juan MONTOJO, San Diego, CA (US); Ozcan OZTURK, San Diego, CA (US)

(21) Appl. No.: 17/304,729

(22) Filed: Jun. 24, 2021

(51) Int. Cl. H04W 72/12; H04W 72/04

(52) U.S. Cl. CPC H04W 72/1263; H04W 72/1242; H04W 72/0446; H04W 72/0406

(57) ABSTRACT

Wireless communications systems and methods related to communicating control information are provided. A method of wireless communication performed by a user equipment (UE) may include mapping a transport block (TB) to a first sub-physical sidelink shared channel (sub-PSSCH) of a plurality of sub-PSSCHs of a PSSCH and transmitting, to at least one other UE, the TB via the first sub-PSSCH.

### TECHNICAL FIELD

This application relates to wireless communication systems, and more particularly to methods and devices for wireless communication using sub-slot based physical sidelink shared channels.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed bands and/or unlicensed bands.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication performed by a user equipment (UE) may include mapping a transport block (TB) to a first sub-physical sidelink shared channel (sub-PSSCH) of a plurality of sub-PSSCHs of a PSSCH; and transmitting, to at least one other UE, the TB via the first sub-PSSCH.

In an additional aspect of the disclosure, a method of communication performed by a base station (BS) may include transmitting, to a user equipment, a configuration indicating a plurality of sub-PSSCHs within a slot, wherein the configuration comprises a number of the sub-PSSCHs; a starting position of each sub-PSSCH of the plurality of sub-PSSCHs; and a duration of each sub-PSSCH of the plurality of sub-PSSCHs.

In an additional aspect of the disclosure, a UE may include a transceiver, a memory, and a processor coupled to the transceiver and the memory, the UE may be configured to map a transport block (TB) to a first sub-physical sidelink shared channel (sub-PSSCH) of a plurality of sub-PSSCHs of a PSSCH; and transmit, to at least one other UE, the TB via the first sub-PSSCH.

In an additional aspect of the disclosure, a BS may include a transceiver, a memory, and a processor coupled to the transceiver and the memory, the BS may be configured to transmit, to a user equipment, a configuration indicating a plurality of sub-PSSCHs within a slot, wherein the configuration comprises a number of the sub-PSSCHs; a starting position of each sub-PSSCH of the plurality of sub-PSSCHs; and a duration of each sub-PSSCH of the plurality of sub-PSSCHs.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates sidelink resources associated with a wireless communication network according to some aspects of the present disclosure.

FIG. 3 illustrates transport blocks mapped to sub-PSSCHs in a slot according to some aspects of the present disclosure.

FIG. 4 illustrates sub-PSSCHs partitioned on a resource element boundary according to some aspects of the present disclosure.

FIG. 5 illustrates physical sidelink feedback channels mapped to sub-PSSCHs in a slot according to some aspects of the present disclosure.

FIGS. 6-8 illustrate padding mapped to sub-PSSCHs in a slot according to some aspects of the present disclosure.

FIG. 9 is a block diagram of an exemplary user equipment (UE) according to some aspects of the present disclosure.

FIG. 10 is a block diagram of an exemplary base station (BS) according to some aspects of the present disclosure.

FIG. 11 is a flow diagram of a communication method according to some aspects of the present disclosure.

FIG. 12 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The present application describes mechanisms for wireless network devices to communicate transport blocks (TBs) to multiple UEs via sub-PSSCHs in a slot. The disclosed approaches include various methods of partitioning the sub-PSSCHs in the slot and mapping the TBs to the sub-PSSCHs. The disclosed approaches further include various methods of transmitting the TBs to UEs that communicate using sidelink communications.

In some aspects of the present disclosure, the latency of wireless communications, including sidelink control and data communications, may be reduced by transmitting multiple TBs in sub-PSSCHs in a slot as compared to transmitting a single TB to a single UE in the slot.

In accordance with the present disclosure, partitioning a slot into multiple PSSCHs and mapping TBs to the sub-PSSCHs for transmission to multiple UEs may facilitate more efficient use and optimization of the frequency resources, higher reliability of the wireless communications network, and reduced transmission latency. In this regard, wireless communication applications requiring low latency such as vehicle-to-everything (V2X) and industrial Internet-of-Things (IoT) may benefit from the methods and devices of the present disclosure.

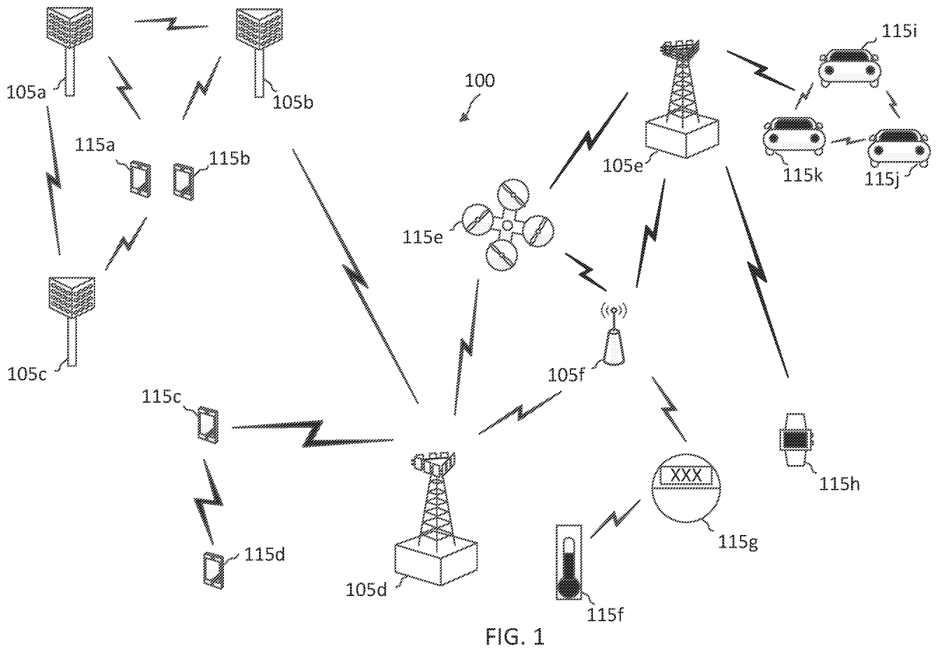

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

In some aspects, the UE 115g (e.g., a meter, a programmable logic controller, an IoT device, a robot, a vehicle, etc.) may map a transport block (TB) to a first sub-physical sidelink shared channel (sub-PSSCH) of a plurality of sub-PSSCHs of a PSSCH. In some aspects, the UE 115g may map multiple TBs to multiple sub-PSSCHs within a slot for transmission to multiple UEs (e.g., UEs 115h, 115f). In some instances, each of the TBs mapped in a sub-PSSCH may be transmitted to a different UE over a sidelink channel. In this manner, the transmitting UE 115g may increase the utilization of time/frequency resources within a single slot as compared to only transmitting to a single UE per slot. By partitioning the symbols and/or resource elements into multiple sub-PSSCHs within the slot, each sub-PSSCH may carry a different TB destined to a different UE.

In some aspects, the BS 105f may transmit, to UE 115g, a configuration indicating a plurality of sub-PSSCHs within a slot. The configuration may include, without limitation, a number of the sub-PSSCHs, a starting position of each sub-PSSCH, and a duration of each sub-PSSCH of the plurality of sub-PSSCHs. In this regard, the BS 105f may transmit the configuration in an RRC configuration message, a DCI, and/or MAC control element signaling via a physical downlink shared channel (PDSCH), a physical downlink control channel (PDCCH), or other suitable channel. The configuration transmitted by the BS 105f may be received by the UE 115g and used by the UE 115g to partition a slot into sub-PSSCHs, map the TBs to the sub-PSSCHs, configure the SCI-1, and/or configure the SCI-2.

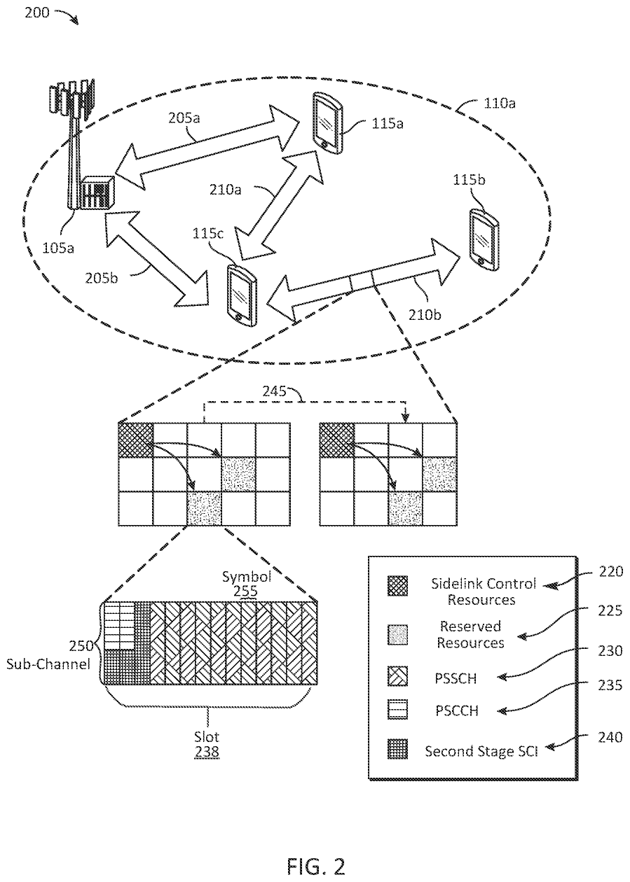

FIG. 2 illustrates sidelink resources associated with a wireless communication network 200 according to some aspects of the present disclosure. The wireless communications network 200 may include a base station 105a and UEs 115a, 115b, and 115c, which may be examples of a BS 105 and a UE 115 as described with reference to FIG. 1. Base station 105a and UEs 115a and 115c may communicate within geographic coverage area 110a and via communication links 205a and 205b, respectively. UE 115c may communicate with UEs 115a and 115b via sidelink communication links 210a and 210b, respectively. In some examples, UE 115c may transmit SCI to UEs 115a and 115b via the sidelink control resources 220. The SCI may include an indication of resources reserved for retransmissions by UE 115c (e.g., the reserved resources 225). In some examples, UEs 115a and 115b may determine to reuse one or more of the reserved resources 225.

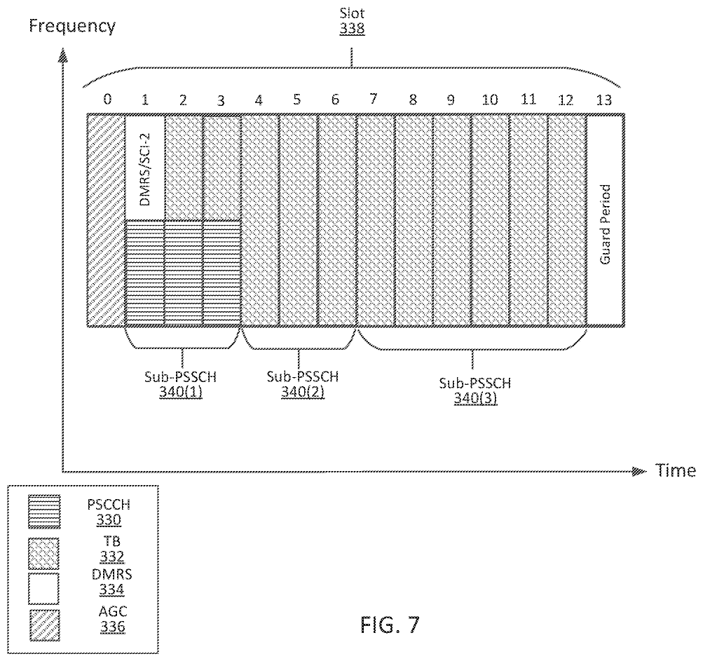

In some aspects, a device in the wireless communication network 200 (e.g., a UE 115, a BS 105, or some other node) may convey SCI to another device (e.g., another UE 115, a BS 105, sidelink device or vehicle-to-everything (V2X) device, or other node). The SCI may be conveyed in one or more stages. The first stage SCI in may be carried on the PSCCH while the second stage SCI may be carried on the corresponding PSSCH. For example, UE 115c may transmit a PSCCH/first stage SCI 235 (e.g., SCI1) to each sidelink UE 115 in the network (e.g., UEs 115a and 115b) via the sidelink communication links 210. The PSSCH/first stage SCI 235 may indicate resources that are reserved by UE 115c for retransmissions (e.g., the SCI1 may indicate the reserved resources 225 for retransmissions). Each sidelink UE 115 may decode the first stage SCI to determine where the reserved resources 225 are located (e.g., to refrain from using resources that are reserved for another sidelink transmission and/or to reduce resource collision within the wireless communications network 200). Sidelink communication may include a mode 1 operation in which the UEs 115 are in a coverage area of BS 105a. In mode 1, the UEs 115 may receive a configured grant from the BS 105a that defines parameters for the UEs 115 to access the channel Mode 1 operations are discussed in more detail with reference to FIG. 7. Sidelink communication may also include a mode 2 operation in which the UEs 115 operate autonomously from the BS 105a and perform sensing of the channel to gain access to the channel. In some aspects, during Mode 2 sidelink operations, the sidelink UEs 115 may perform channel sensing to locate resources reserved by other sidelink transmissions. The first stage SCI may reduce the need for sensing each channel. For example, the first stage SCI may include an explicit indication such that the UEs 115 may refrain from blindly decoding each channel. The first stage SCI may be transmitted via the sidelink control resources 220. The sidelink control resources 220 may be configured resources (e.g., time resources or frequency resources) transmitted via a PSCCH 235. In some examples, the PSCCH 235 may be configured to occupy a number of physical resource blocks (PRBs) within a selected frequency. The frequency may include a single subchannel 250 (e.g., 10, 12, 15, 20, 25, or some other number of RBs within the subchannel 250). The time duration of the PSCCH 235 may be configured (e.g., the PSCCH 235 may span 2, 3, or some other number of symbols 255).

The first stage SCI may include one or more fields to indicate a location of the reserved resources 225. For example, the first stage SCI may include, without limitation, one or more fields to convey a frequency domain resource allocation (FDRA), a time domain resource allocation (TDRA), a resource reservation period 245 (e.g., a period for repeating the SCI transmission and the corresponding reserved resources 225), a modulation and coding scheme (MCS) for a second stage SCI 240, a beta offset value for the second stage SCI 240, a DMRS port (e.g., one bit indicating a number of data layers), a physical sidelink feedback channel (PSFCH) overhead indicator, a priority, one or more additional reserved bits, or a combination thereof. In some examples, the FDRA may be a number of bits in the first stage SCI that may indicate a number of slots and a number of subchannels reserved for the reserved resources 225 (e.g., a receiving UE 115 may determine a location of the reserved resources 225 based on the FDRA by using the subchannel 250 including the PSCCH 235 and first stage SCI as a reference). The TDRA may be a number of bits in the first stage SCI (e.g., 5 bits, 9 bits, or some other number of bits) that may indicate a number of time resources reserved for the reserved resources 225. In this regard, the first stage SCI may indicate the reserved resources 225 to the one or more sidelink UEs 115 in the wireless communication network 200.

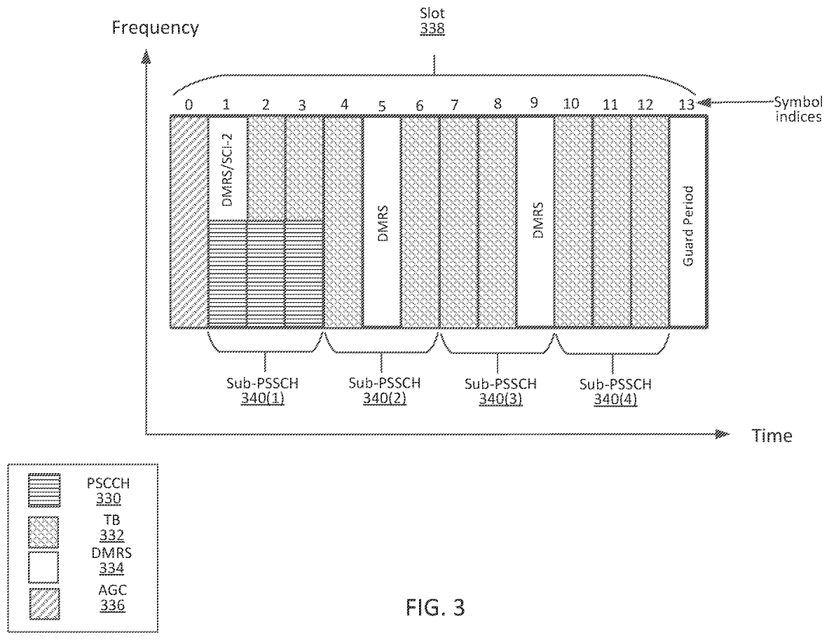

The sidelink UEs 115 may attempt to decode the reserved resources 225 indicated by the first stage SCI. In some aspects, the reserved resources 225 may be used for retransmission of sidelink data or the first stage SCI. Additionally or alternatively, the reserved resources 225 may include resources for sidelink transmissions, such as a PSSCH 230. As will be described in detail below with reference to FIGS. 3-8, the PSSCH 230 may be partitioned into multiple sub-PSSCHs. The sub-PSSCHs may be transmitted via one or more symbols 255. In some examples, the PSSCH 230 may include the PSCCH 235 (e.g., the PSCCH 235 may be transmitted via one or more time or frequency resources via one or more full or partial symbols 255 of the PSSCH 230). A second stage SCI 240 may be transmitted via one or more symbols 255 of the PSSCH 230. The second stage SCI 240 may be transmitted in a symbol(s) near or at the beginning of a PSCCH/PSSCH slot. The second stage SCI 240 may include an indication of which of the reserved resources 225 the transmitting UE 115 may use for sidelink transmissions. The second stage SCI 240 may thereby be received and decoded by sidelink UEs 115 intended to receive and decode the corresponding sidelink communications.

In some aspects, the transmitting UE 115 may transmit first-stage SCI-1 to one or more receiving UEs 115 indicating whether multiple sub-PSSCHs 230 are enabled or disabled for the slot 238. In this regard, the transmitting UE 115 may transmit the SCI-1 over the PSCCH 235. The UE 115 may transmit the SCI-1 that indicates a sub-PSSCH configuration in the time and/or frequency domain for the multiple sub-PSSCHs. The UE 115 may transmit a PSCCH 235 communication that includes SCI-1 control information applicable to all of the sub-PSSCHs in the slot. Additionally or alternatively, the UE 115 may transmit a PSCCH 235 communication that includes SCI-1 control information applicable to one or more sub-PSSCHs and/or a subset of the sub-PSSCHs in the slot 238. The UE 115 may transmit an SCI-1 that indicates a common modulation and coding scheme for all sub-PSSCHs in the slot 238.

In some aspects, the UE 115 may transmit a combined second-stage SCI-2 including sidelink control information for each of the sub-PSSCHs of the plurality of sub-PSSCHs in the slot 238. In this regard, the UE 115 may transmit the SCI-2 in the first sub-PSSCH of the plurality of sub-PSSCHs. The combined SCI-2 may override a common modulation and coding scheme in the SCI-1 for the sub-PSSCHs with a per-sub-PSSCH modulation and coding scheme indicated in the combined SCI-2. The UE 115 may transmit the SCI-1 including an indicator that indicates one or more values of a rate matching parameter for the combined SCI-2 corresponding to the plurality of sub-PSSCHs within the slot 238. In some aspects, the UE 115 may transmit the combined SCI-2 as a concatenation of sub-SCI-2s for each of the sub-PSSCHs. In this regard, the SCI-2 may include a common field for the source ID. The UE 115 may pad the fields of the sub-SCI-2s associated with sub-PSSCHs that do not have TBs mapped to them. The UE 115 may pad the fields of the sub-SCI-2s with a default value so the combined SCI-2 has the same payload irrespective how many sub-PSSCHs are scheduled to transmit TBs. The SCI-2 may include a concatenation of SCI-2 fields for each sub-PSSCH in which each SCI-2 field includes a HARQ ID, NDI, RV, destination ID, CSI request, MCS, PFSCH resource indication including the K1 offset to the associated PSFCH resource, the PSFCH resource index, and the parameters associated with the PSFCH resource hashing.

FIG. 3 illustrates transport blocks (TBs) 332 mapped to sub-PSSCHs 340 in a slot 338 according to some aspects of the present disclosure. In FIG. 3, the x-axis represents time in some arbitrary units and the Y-axis represents frequency in some arbitrary units. The UE (e.g., the UE 115, the UE 900) may map a TB 332 to any or all of the sub-PSSCHs 340 in a slot 338. In some aspects, the UE 115 may map multiple TBs 332 to multiple sub-PSSCHs 340 within the slot 338. In some instances, each of the TBs 332 mapped in a sub-PSSCH 340 may be destined to a different UE over a sidelink channel. In this manner, the transmitting UE 115 may increase the utilization of time/frequency resources within the slot 338 as compared to only transmitting to a single UE in the slot 338. By partitioning the symbols and/or resource elements into multiple sub-PSSCHs 340 within the slot 338, each sub-PSSCH 340 may include a different TB 332 destined to a different receiving UE 115.

In some aspects, the UE 115 may partition the slot 338 into multiple sub-PSSCHs 340. In some instances, the UE 115 may partition the slot 338 such that each of the sub-PSSCHs 340 is scheduled to occupy multiple symbols within the slot. For example, the slot 338 may include 14 symbols indicated by symbol indexes 0 to 13. Symbol 0 may include automatic gain control (AGC) 336. AGC 336 may be used by a receiving UE 115 for gain control of an amplifier. The received signal may vary over a wide dynamic range depending on the channel attenuation and interference. AGC 336 may be used by the receiving UEs amplifier to adjust the strength of the received signal in order to reduce the quantization error of the signal. The sub-PSSCH 340 may occupy 2, 3, 4, 5, 6, or more symbols. In some instances, each sub-PSSCH 340 may occupy contiguous symbols within the slot 338. In this regard, each sub-PSSCH 340 may occupy groups of symbols that are contiguous in time. The group of contiguous symbols may include any number of symbols contained within the slot 338. For example, the sub-PSSCH 340(1) may occupy symbol indexes 2, 3, and 4. The sub-PSSCH 340(1) may include the SCI-1 carried in the PSCCH 330. The sub-PSSCH 340(2) may occupy, symbol indexes 4, 5, and 6. The sub-PSSCH 340(3) may occupy symbol indexes 7, 8, and 9. The sub-PSSCH 340(4) may occupy symbol indexes 10, 11, and 12. Although the example of FIG. 3 shows slot 338 partitioned into four sub-PSSCHs 340 each occupying three symbols, the present disclosure is not so limited and the UE 115 may partition any number of sub-PSSCHs 340 occupying any number of symbols.

In some aspects, the UE 115 may transmit a sub-PSSCH 340 that includes at least one demodulation reference signal (DMRS) 334. The DMRS 334 may be a reference signal used by the receiving UE 115 for channel estimation and compensating for Doppler effects at high mobility. The DMRS 334 may be included in each sub-PSSCH 340. In this regard, the DMRS 334 may be located anywhere within the sub-PSSCH 340. The DMRS 334 may be located in the first symbol of the sub-PSSCH 340, the last symbol of the sub-PSSCH 340, or any symbol of the sub-PSSCH 340. For example, sub-PSSCH 340(1) may include the DMRS 334 in symbol index 1, sub-PSSCH 340(2) may include the DMRS 334 in symbol index 5, sub-PSSCH 340(3) may include the DMRS 334 in symbol index 9. In some instances, the DMRS 334 may include all resource elements (REs) within the symbol as shown in symbols indexes 5 and 9. In some aspects, the DMRS 334 may include a portion of the REs within the symbol as shown in symbol index 1.

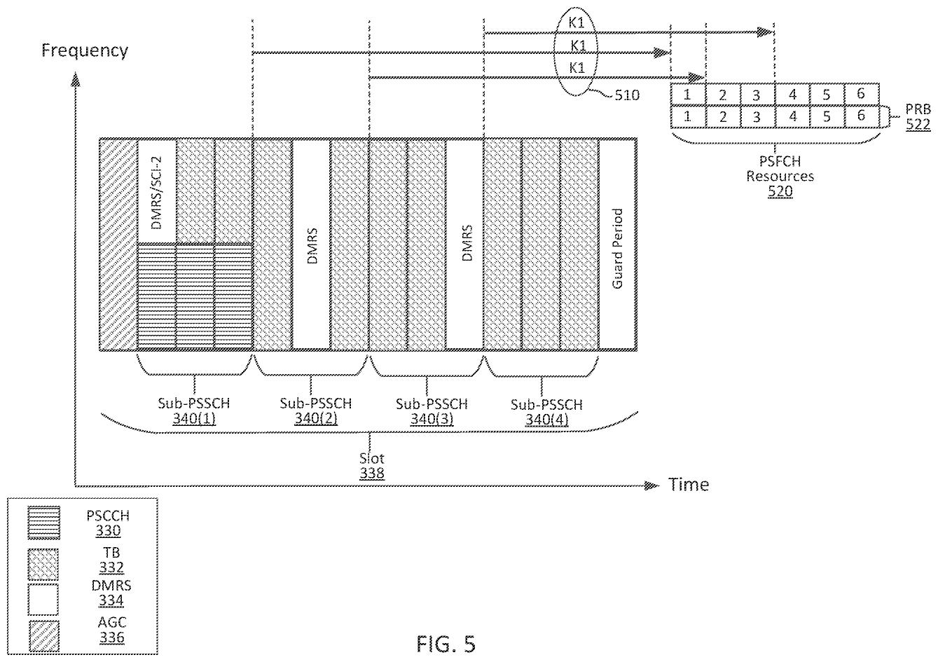

In some aspects, the UE 115 may transmit a sub-PSSCH 340 without a DMRS 334. In this regard, the UE 115 may transmit certain sub-PSSCHs 340 that include a DMRS 334 and transmit certain other sub-PSSCHs 340 that do not include a DMRS. For example, sub-PSSCHs 340(1) . . . (3) include a DMRS 334 while sub-PSSCH 340(4) does not include a DMRS 334. A receiving UE 115 may utilize the DMRS 334 in order to properly estimate the channel and decode control information and data received in a TB 332. In this regard, a UE 115 that receives a TB 332 within a sub-PSSCH 340 may use the DMRS 334 of another sub-PSSCH 340 in order to estimate the channel and decode the TB 332. For example, a transmitting UE 115 may map a TB 332 to a sub-PSSCH 340(3) in symbols 7, 8, and 9 that is destined for a first receiving UE 115. The DMRS 334 may be located in symbol 9. The transmitting UE 115 may also map a TB 332 to the sub-PSSCH 340(4) in symbols 10, 11, and 12 that is destined for a second receiving UE 115. As shown in FIG. 5, symbols 10, 11, and 12 include a TB 332 but do not include a DMRS 334. The second receiving UE 115 may receive the DMRS 334 located in symbol 9 and perform channel estimation. The second receiving UE 115 may receive the TB 332 mapped to the sub-PSSCH 340(4) in symbols 10, 11, and 12 and successfully decode the TB 332 based on the channel estimation performed using the DMRS 334 of symbol 9. In some aspects, the second UE 115 that uses the DMRS 334 from the sub-PSSCH 340(3) that is received earlier than the sub-PSSCH 340(4) that includes the TB 332 for the second UE 115 may decrease a coding and/or processing delay compared to the second UE 115 using a DMRS 334 in the sub-PSSCH 340(4).

In some aspects, the UE 115 may map the TB 332 to a sub-PSSCH 340 based on a priority level associated with the TB 332. In this regard, the UE 115 may determine a priority level of the TB 332 based on the type of data to be transmitted (e.g., an actuator control message, a safety message, sensor measurements, actuator controls, entertainment content, voice, text, authentication, financial data, etc.). In some aspects, the UE 115 may determine the priority level based on categories of data defined in a standard (e.g., 3GPP standard, SAE standard, IEEE standard, etc.). In some aspects, the transmitting UE 115 may not determine the priority level of the TB 332 but may instead receive an indication of the priority level of the TB 332 in a message from another node. For example, the UE 115 may determine the priority level based on communication received from another node in the communications network 100 (e.g., another UE 115, a BS 105, a server, a core network node, etc.). The UE 115 may determine the priority level based on absolute values. The absolute values may be integer values based on categories of priority levels. For example, a priority level of one may be the highest priority level. In some aspects, the UE 115 may determine the priority level based on relative priority levels between the TBs 332. For example, a first TB 332 may have a lower priority level than a second TB 332, the second TB 332 may have a lower priority level than a third TB 332, etc. The UE 115 may map a TB 332 having a high priority to a sub-PSSCH 340 at a location earlier in the slot 338 than a TB 332 having a lower priority. Symbols having a lower index (e.g., 0, 1, 2, 3) occur earlier in time than symbols having a higher index (e.g., 10, 11, 12, 13). For example, the UE 115 may map a TB 332 having a high priority to the sub-PSSCH 340(1) in symbols 1, 2, and 3, while mapping a TB 332 having a lower priority to the sub-PSSCH 340(4) in symbols 10, 11, and 12. The priority level of a TB 332 may be associated with a latency requirement of the TB 332. A higher priority level may be associated with a lower latency requirement. In this regard, scheduling the TBs 332 with higher priority sooner than the TBs 332 with lower priority, the latency associated with communication of the higher priority TBs 332 may be reduced compared to the latency associated with communication of the lower priority TBs 332.

In some aspects, the transmitting UE 115 may map the TB 332 to the sub-PSSCH 340 based on a packet delay budget associated with the TB 332. In this regard, the UE 115 may have knowledge of a packet delay budget and/or a latency budget associated with the TB 332. The packet delay budget may be a maximum time to transmit the TB 332 to the receiving UE 115. The packet delay budget may be based on the type of data to be communicated in the TB 332 and/or a UE-type of the receiving UE 115. For example, data related to safety applications associated with UEs 115 performing vehicle-to-vehicle communications may have a lower packet delay budget compared to data related to personal messaging. As another example, data related to communications between robot controllers and sensors/actuators may have a lower packet delay budget compared to data related to content streaming. The UE 115 may determine the packet delay budget associated with the TB 332 based on a configuration received from another node in the communications network (e.g., another UE 115, a BS 105, a server, a core network node, etc.).

The UE 115 may map a TB 332 having a lower packet delay budget to a sub-PSSCH 340 at a location earlier in the slot 338 than a TB 332 having a higher packet delay budget. In this regard, the UE 115 may map a TB 332 having a lower packet delay budget to the sub-PSSCH 340(1) occupying symbols 1, 2, and 3, while mapping a TB 332 having a higher packet delay budget to the sub-PSSCH 340(4) occupying symbols 10, 11, and 12. By scheduling the TBs 332 with lower packet delay budget sooner than the TBs 332 with higher packet delay budget, the latency associated with communication of the TBs 332 having a lower packet delay budget may be reduced compared to the latency associated with communication of TBs 332 having higher packet delay budget.

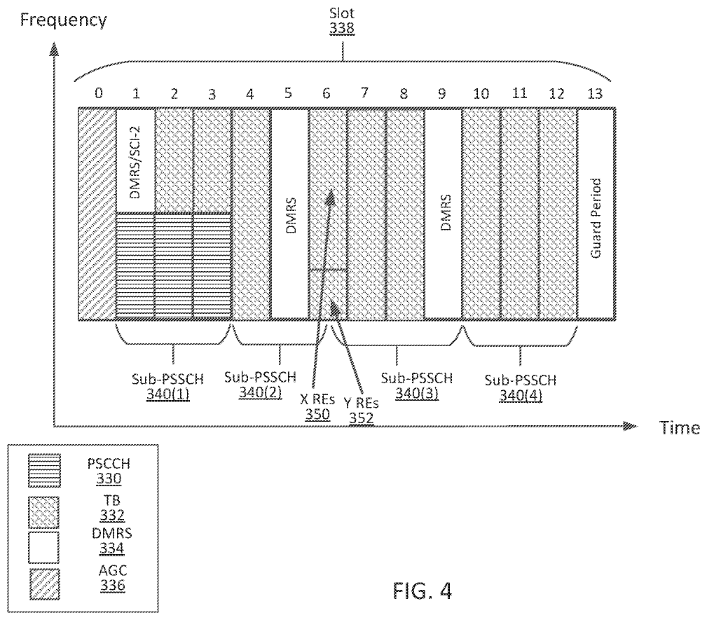

FIG. 4 illustrates transport blocks (TBs) 332 mapped to sub-PSSCHs 340 in a slot 338 according to some aspects of the present disclosure. In FIG. 4, the x-axis represents time in some arbitrary units and the Y-axis represents frequency in some arbitrary units. The UE (e.g., the UE 115, the UE 900) may map a transport block (TB) 332 to any or all of the sub-PSSCHs 340 in a slot 338. In some aspects, the UE 115 may map multiple TBs 332 to multiple sub-PSSCHs 340 within the slot 338. In some instances, each of the TBs 332 mapped in a sub-PSSCH 340 may be destined to a different UE over a sidelink channel. In this manner, the transmitting UE 115 may increase the utilization of time/frequency resources within the slot 338 as compared to only transmitting to a single UE in the slot 338. By partitioning the symbols and/or resource elements into multiple sub-PSSCHs 340 within the slot 338, each sub-PSSCH 340 may include a different TB 332 destined to a different UE.

In some aspects, the UE 115 may partition the slot 338 into multiple sub-PSSCHs 340. In some instances, the UE 115 may partition the slot 338 such that each of the sub-PSSCHs 340 is scheduled to occupy multiple symbols within the slot. As described above with reference to FIG. 3, a sub-PSSCH 340 may occupy 2, 3, 4, 5, 6, or more symbols. In some instances, each sub-PSSCH 340 may occupy contiguous symbols within the slot 338. In this regard, each sub-PSSCH 340 may occupy groups of symbols that are contiguous in time. In contrast to FIG. 3 in which the sub-PSSCHs 340 are partitioned on a symbol boundary, in FIG. 4, the UE 115 may partition the sub-PSSCHs 340 across a resource element (RE) boundary. In this regard, each of the sub-PSSCHs 340 may occupy multiple REs within the slot 338. The slot 338 may include 14 symbols in the time domain. Each RE may include one subcarrier (e.g., 15 kHz, 30 kHz, 60 kHz, 120 kHz, etc.) in the frequency domain and one symbol in the time domain. Each sub-PSSCH 340 may occupy groups of REs that are contiguous in frequency and/or time. Each group of REs may include a whole number of REs and not include any partial REs. Each sub-PSSCH 340 may include any number of REs contained within the slot 338. The REs of adjacent sub-PSSCHs 340 may be contiguous. For example, the sub-PSSCH 340(2) may occupy all the REs in symbol indexes 4, 5, and x REs 350 in symbol 6. The sub-PSSCH 340(3), adjacent to the sub-PSSCH 340(2), may occupy Y REs 352 which are the remaining resource elements in symbol 6 (total number of REs in symbol index 6-x) and all the REs in symbols 7, 8, and 9. In some aspects, each symbol may include 12 consecutive REs with a 15 kHz subcarrier spacing. For example, the sub-PSSCH 340(2) may occupy 10 REs in symbol index 6 covering 150 kHz and the sub-PSSCH 340(3) may occupy the remaining 2 REs covering 30 kHz indicated as Y REs 352 in symbol index 6.

FIG. 5 illustrates physical sidelink feedback channels (PSFCH) 520 mapped to sub-PSSCHs 340 in a slot 338 according to some aspects of the present disclosure. In FIG. 5, the x-axis represents time in some arbitrary units and the Y-axis represents frequency in some arbitrary units. In some aspects, the UE 115 may map at least one PSFCH resource 520 to each sub-PSSCH 340(1) . . . (4). In this regard, the PSFCH resources 520 may be used to communicate sidelink feedback, such as hybrid automatic repeat request (HARQ) feedback (e.g., acknowledgement or negative acknowledgement (ACK/NACK) information), transmit power control (TPC), and/or a scheduling request (SR), for the associated sub-PSSCH 340. In some aspects, each sub-PSSCH 340 within a slot 338 may correspond to particular PSFCH resource 520. Having each sub-PSSCH 340 associated with a corresponding PSFCH resource 520 may reduce latency for reporting sidelink feedback, which may further assist with enabling low latency communication and more efficient use of network resources. The UE 115 may map each TB 332 in a sub-PSSCH 340 to Z physical resource blocks (PRBs) 522 of the PSFCH resources 520. The Z PRBs may carry Z×Y PSFCH sequences for PSFCH feedback corresponding to the sub-PSSCH 340 that is mapped to the Z PRBs 522. In this regard, the value of Y may be selected from a set of {1, 2, 3, 4, 6} that represents a number of cyclic shift pairs (e.g., a dimension in the code domain). When a UE 115 transmits to a receiving UE 115 via a particular sub-PSSCH 340, the receiving UE 115 may determine one or more PRBs 522 of the PSFCH resources 520 that are mapped to the particular sub-PSSCH 340. The receiving UE 115 may transmit HARQ feedback on the one or more PRBs 522. The transmitting UE 115 may monitor the one or more PRBs 522 for the HARQ feedback. Based at least in part on the HARQ feedback, the transmitting UE 115 may determine whether to retransmit the TB 322 that was transmitted in the particular sub-PSSCH 340.

In some aspects, the transmitting UE 115 may indicate to a receiving UE 115 the PSFCH resources 520 associated with a sub-PSSCH 340. In some instances, the UE 115 may transmit a second stage SCI (SCI-2) to the receiving UE 115. The SCI-2 may indicate one or more PSFCH resources 520 for transmission of HARQ feedback (e.g., ACK/NACK feedback) associated with a corresponding sub-PSSCH 340. For example, the SCI-2 for a sub-PSSCH 340 may indicate a K1 value indicated as reference numeral 510 that indicates an offset between the sub-PSSCH 340 (e.g., a starting symbol of the sub-PSSCH 340 or an ending symbol of the sub-PSSCH 340) and a corresponding PSFCH resource 520 (e.g., a time and/or frequency domain resource) in which HARQ feedback, corresponding to the sub-PSSCH 340, is to be transmitted. In this regard, the K1 offset 510 may be indicated as a number of symbols to enable greater scheduling flexibility and reduced latency as compared to signaling a slot 338 for the HARQ feedback. Additionally or alternatively, the SCI-2 may indicate a resource index for the PSFCH resource 520 (e.g., a time domain resource index, a frequency domain resource index, and/or a PRB index).

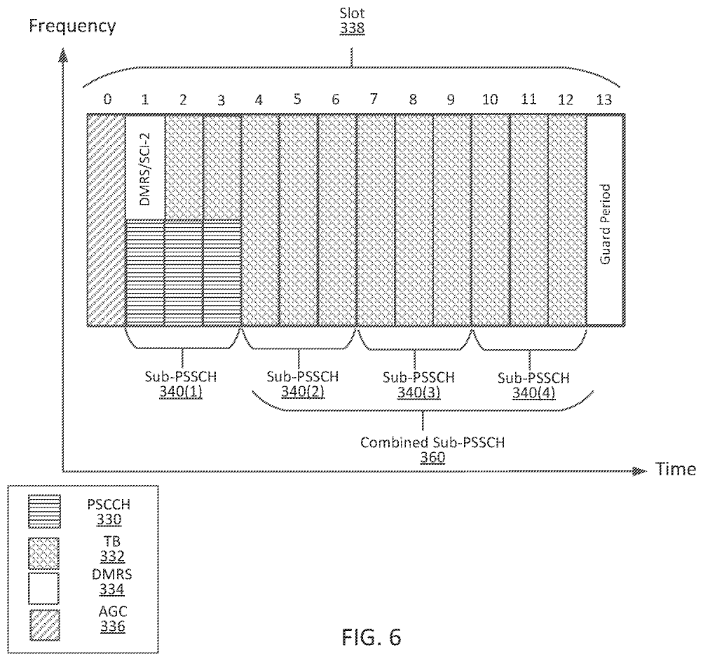

FIGS. 6-8 illustrate padding mapped to sub-PSSCHs 340 in a slot 338 according to some aspects of the present disclosure. In FIGS. 6-8, the x-axis represents time in some arbitrary units and the Y-axis represents frequency in some arbitrary units. In some aspects, the UE 115 may transmit padding in one or more sub-PSSCHs 340. In this regard, when the UE 115 maps a TB 332 in one or more sub-PSSCHs 340 within a slot 338, but in fewer than all of the sub-PSSCHs 340 within the slot 338, then the UE 115 may transmit padding in the empty sub-PSSCHs 340. An “empty sub-PSSCH” may include a sub-PSSCH 340 that is not scheduled for a data transmission and/or a sub-PSSCH 340 that does not carry a TB 332. For example, when a UE 115 partitions a slot into 4 sub-PSSCHs 340(1) . . . 340(4), the UE 115 may map TBs 332 into the sub-PSSCHs 340(1) and 340(4) while the sub-PSSCHs 340(2) and 340(3) are not scheduled to carry a TB. In this scenario, the transmitting UE 115 would not normally transmit in the sub-PSSCHs 340(2) and 340(3). However, if the UE 115 transmits in only a subset of the sub-PSSCHs 340 of the slot 338, then this sub-PSSCH 340 mapping may cause power transmission variation and disrupt proper reception of the sub-PSSCHs 340 by the receiving UE 115. To reduce power variation, the UE 115 may transmit padding in sub-PSSCHs 340(2) and 340(3). In some aspects, the padding may include a reference signal, which may be used to improve data reception. Additionally or alternatively, the padding within a sub-PSSCH 340 may include a repetition of the sub-PSSCHs 340(1) or 340(4). By retransmitting TBs 332 in the sub-PSSCHs 340(2) and 340(3), the likelihood of successful reception of the TBs 332 may be improved.

In some aspects, the UE 115 may transmit padding in all empty sub-PSSCHs 340 within the slot 338 if the UE 115 transmits in any sub-PSSCHs 340, thereby reducing power variation. In some instances, the UE 115 may map the same TB 332 to two or more sub-PSSCHs 340. For example, as shown in FIG. 6, a UE 115 may map a first TB 332 to sub-PSSCH 340(1) in symbol indexes 1, 2, and 3. The UE 115 may also have a second TB 332 that includes an amount of data that fits within sub-PSSCH 340(2) in symbol indexes 4, 5, and 6. The UE 115 may pad the remaining sub-PSSCHs 340(3) and 340(4) by mapping the second TB 332 into a combined sub-PSSCH 360 that includes symbols 4-12. The UE 115 may rate match the second TB 332 with the sub-PSSCHs 340(2) . . . 340(4) in the combined sub-PSSCH 360.

Additionally or alternatively the UE 115 may pad the empty sub-PSSCHs 340 with a repetition of a TB 332. Referring to FIG. 7, the UE 115 may map a first TB 332 to sub-PSSCH 340(1) in symbol indexes 1, 2, and 3. The UE 115 may also have a second TB 332 that includes an amount of data that fits within sub-PSSCH 340(2) in symbol indexes 4, 5, and 6. The UE 115 map the second TB 332 into the sub-PSSCH 340(2). The UE 115 may also partition the slot 338 to include the sub-PSSCH 340(3) occupying symbol indexes 7-12. The UE 115 may map the second TB 332 into the sub-PSSCH 340(3) as a retransmission of the second TB 332. By retransmitting the second TB 332 in the sub-PSSCH 340(3) occupying symbol indexes 7-12, the likelihood of successful reception of the second TB 332 may be improved.

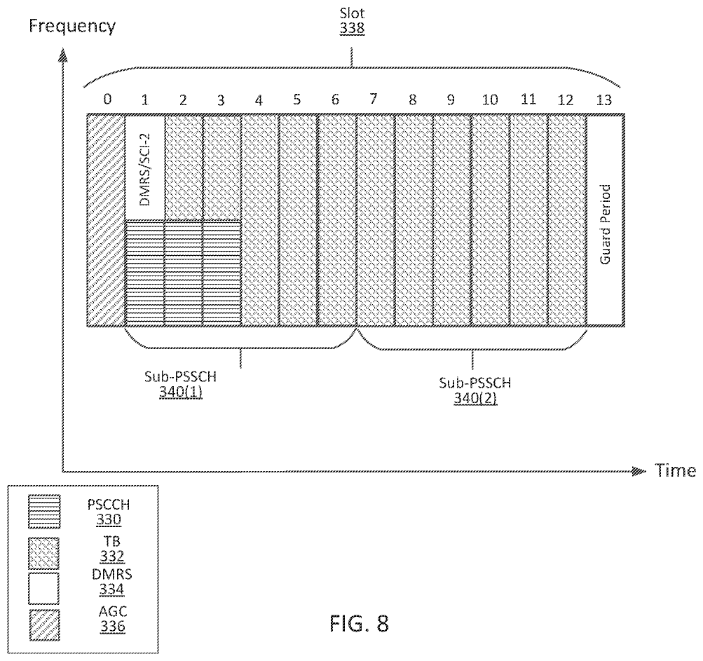

Additionally or alternatively, the UE 115 may map the scheduled TBs 332 by distributing the TBs 332 over the sub-PSSCHs 340. Referring to FIG. 8, the UE 115 may have two TBs 332 scheduled for transmission. The size of each of the two TBs 332 may fit in three symbols. The UE 115 may partition the slot 338 into two sub-PSSCHs 340(1) and 340(2). Each of the two sub-PSSCHs 340(1) and 340(2) may include six symbols. The sub-PSSCH 340(1) may include symbols indexes 1-6 and the sub-PSSCH 340(2) may include symbol indexes 7-12. The UE 115 may map and rate match the two TBs 332 into the two sub-PSSCHs 340(1) and 340(2) having six symbols each rather than map the two TBs 332 into two sub-PSSCHs 340 having three symbols each and leaving the remaining symbols empty. By mapping and rate matching the two TBs 332 into the two sub-PSSCHs 340(1) and 340(2) having six symbols each, the UE may increase the coding gain and increase the probability of successful decoding by the receiving UEs 115 as compared to mapping the two TBs 332 into two sub-PSSCHs 340 having three symbols.

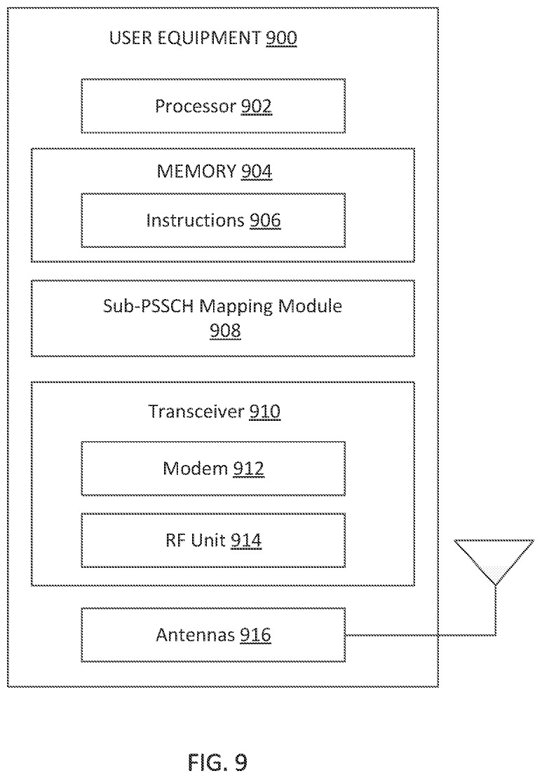

FIG. 9 is a block diagram of an exemplary UE 900 according to some aspects of the present disclosure. The UE 900 may be the UE 115 in the network 100 as discussed above. As shown, the UE 900 may include a processor 902, a memory 904, a sub-PSSCH mapping module 908, a transceiver 910 including a modem subsystem 912 and a radio frequency (RF) unit 914, and one or more antennas 916. These elements may be coupled with each other and in direct or indirect communication with each other, for example via one or more buses.

The processor 902 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 904 includes a non-transitory computer-readable medium. The memory 904 may store instructions 906. The instructions 906 may include instructions that, when executed by the processor 902, cause the processor 902 to perform the operations described herein with reference to the UEs 115 in connection with aspects of the present disclosure, for example, aspects of FIGS. 2-8 and 11-12. Instructions 906 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The sub-PSSCH mapping module 908 may be implemented via hardware, software, or combinations thereof. For example, the sub-PSSCH mapping module 908 may be implemented as a processor, circuit, and/or instructions 906 stored in the memory 904 and executed by the processor 902.

The sub-PSSCH mapping module 908 may be used for various aspects of the present disclosure, for example, aspects of FIGS. 2-8 and 11-12. The sub-PSSCH mapping module 908 is configured to map a transport block (TB) to a first sub-PSSCH of a plurality of sub-PSSCHs of a PSSCH and transmit, to at least one other UE, the TB via the first sub-PSSCH. In this regard, the processor 902 may execute instructions 906 to map a TB to a first sub-PSSCH. The processor 902 may execute instructions 906 to map multiple TBs to multiple sub-PSSCHs. The transceiver 910 may transmit the TBs to multiple other UEs. The transceiver 910 may also be configured to transmit to at least one other UE, a demodulation reference signal, padding, SCI-1, and/or SCI-2 via a sub-PSSCH of the plurality of sub-PSSCHs.

As shown, the transceiver 910 may include the modem subsystem 912 and the RF unit 914. The transceiver 910 can be configured to communicate bi-directionally with other devices, such as the BSs 105 and/or the UEs 115. The modem subsystem 912 may be configured to modulate and/or encode the data from the memory 904 and the sub-PSSCH mapping module 908 according to a modulation and coding scheme (MCS), e.g., a low-density parity check (LDPC) coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data from the modem subsystem 912 (on outbound transmissions) or of transmissions originating from another source such as a UE 115 or a BS 105. The RF unit 914 may be further configured to perform analog beamforming in conjunction with the digital beamforming. Although shown as integrated together in transceiver 910, the modem subsystem 912 and the RF unit 914 may be separate devices that are coupled together to enable the UE 900 to communicate with other devices.

The RF unit 914 may provide the modulated and/or processed data, e.g. data packets (or, more generally, data messages that may contain one or more data packets and other information), to the antennas 916 for transmission to one or more other devices. The antennas 916 may further receive data messages transmitted from other devices. The antennas 916 may provide the received data messages for processing and/or demodulation at the transceiver 910. The antennas 916 may include multiple antennas of similar or different designs in order to sustain multiple transmission links. The RF unit 914 may configure the antennas 916.

In some instances, the UE 900 can include multiple transceivers 910 implementing different RATs (e.g., NR and LTE). In some instances, the UE 900 can include a single transceiver 910 implementing multiple RATs (e.g., NR and LTE). In some instances, the transceiver 910 can include various components, where different combinations of components can implement RATs.

In some aspects, the processor 902 may be coupled to the memory 904, the sub-PSSCH mapping module 908, and/or the transceiver 910. The processor 902 and may execute operating system (OS) code stored in the memory 904 in order to control and/or coordinate operations of the sub-PSSCH mapping module 908 and/or the transceiver 910. In some aspects, the processor 902 may be implemented as part of the sub-PSSCH mapping module 908. In some aspects, the processor 902 is configured to transmit via the transceiver 910, to another UE, TBs in sub-PSSCHs.

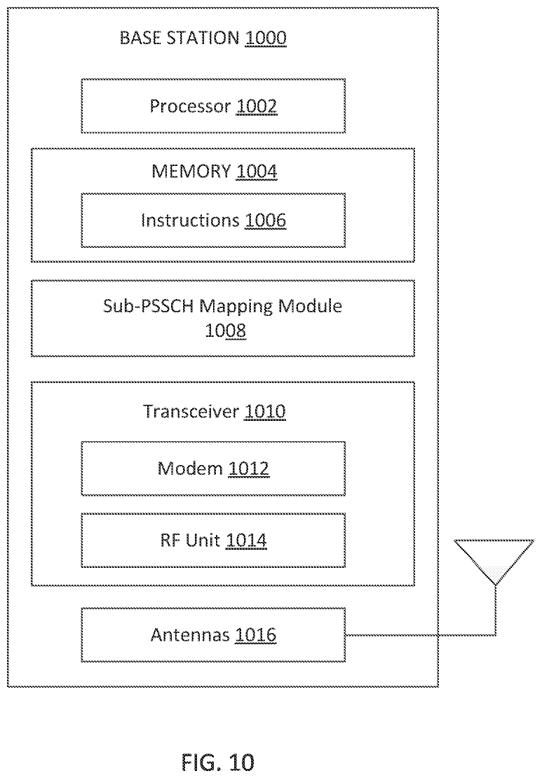

FIG. 10 is a block diagram of an exemplary BS 1000 according to some aspects of the present disclosure. The BS 1000 may be a BS 105 as discussed above. As shown, the BS 1000 may include a processor 1002, a memory 1004, a sub-PSSCH mapping module 1008, a transceiver 1010 including a modem subsystem 1012 and a RF unit 1014, and one or more antennas 1016. These elements may be coupled with each other and in direct or indirect communication with each other, for example via one or more buses.

The processor 1002 may have various features as a specific-type processor. For example, these may include a CPU, a DSP, an ASIC, a controller, a FPGA device, another hardware device, a firmware device, or any combination thereof configured to perform the operations described herein. The processor 1002 may also be implemented as a combination of computing devices, e.g., a combination of a DSP and a microprocessor, a plurality of microprocessors, one or more microprocessors in conjunction with a DSP core, or any other such configuration.

The memory 1004 may include a cache memory (e.g., a cache memory of the processor 1002), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 1004 may include a non-transitory computer-readable medium. The memory 1004 may store instructions 1006. The instructions 1006 may include instructions that, when executed by the processor 1002, cause the processor 1002 to perform operations described herein, for example, aspects of FIGS. 2-8 and 11-12. Instructions 1006 may also be referred to as code, which may be interpreted broadly to include any type of computer-readable statement(s).

The sub-PSSCH mapping module 1008 may be implemented via hardware, software, or combinations thereof. For example, the sub-PSSCH mapping module 1008 may be implemented as a processor, circuit, and/or instructions 1006 stored in the memory 1004 and executed by the processor 1002.

The sub-PSSCH mapping module 1008 may be used for various aspects of the present disclosure, for example, aspects of FIGS. 2-8 and 11-12. The sub-PSSCH mapping module 1008 is configured to transmit, to a UE (e.g., the UE 115, the UE 900), a configuration indicating a plurality of sub-PSSCHs within a slot, wherein the configuration comprises a number of the sub-PSSCHs, a starting position of each sub-PSSCH, and a duration of each sub-PSSCH of the plurality of sub-PSSCHs. In this regard, the transceiver 1010 may transmit to a UE (e.g., the UE 115, the UE 900), the configuration indicating a plurality of sub-PSSCHs within a slot.

Additionally or alternatively, the sub-PSSCH mapping module 1008 can be implemented in any combination of hardware and software, and may, in some implementations, involve, for example, processor 1002, memory 1004, instructions 1006, transceiver 1010, and/or modem 1012.

As shown, the transceiver 1010 may include the modem subsystem 1012 and the RF unit 1014. The transceiver 1010 can be configured to communicate bi-directionally with other devices, such as the UEs 115 and/or 800. The modem subsystem 1012 may be configured to modulate and/or encode data according to a MCS, e.g., a LDPC coding scheme, a turbo coding scheme, a convolutional coding scheme, a digital beamforming scheme, etc. The RF unit 1014 may be configured to process (e.g., perform analog to digital conversion or digital to analog conversion, etc.) modulated/encoded data from the modem subsystem 1012 (on outbound transmissions) or of transmissions originating from another source such as a UE 115 or UE 800. The RF unit 1014 may be further configured to perform analog beamforming in conjunction with the digital beamforming. Although shown as integrated together in transceiver 1010, the modem subsystem 1012 and/or the RF unit 1014 may be separate devices that are coupled together at the BS 1000 to enable the BS 1000 to communicate with other devices.

The RF unit 1014 may provide the modulated and/or processed data, e.g. data packets (or, more generally, data messages that may contain one or more data packets and other information), to the antennas 1016 for transmission to one or more other devices. This may include, for example, a configuration indicating a plurality of sub-PSSCHs within a slot according to aspects of the present disclosure. The antennas 1016 may further receive data messages transmitted from other devices and provide the received data messages for processing and/or demodulation at the transceiver 1010. The antennas 1016 may include multiple antennas of similar or different designs in order to sustain multiple transmission links.

In some instances, the BS 1000 can include multiple transceivers 1010 implementing different RATs (e.g., NR and LTE). In some instances, the BS 1000 can include a single transceiver 1010 implementing multiple RATs (e.g., NR and LTE). In some instances, the transceiver 1010 can include various components, where different combinations of components can implement RATs.

In some aspects, the processor 1002 may be coupled to the memory 1004, the sub-PSSCH mapping module 1008, and/or the transceiver 1010. The processor 1002 may execute OS code stored in the memory 1004 to control and/or coordinate operations of the sub-PSSCH mapping module 1008, and/or the transceiver 1010. In some aspects, the processor 1002 may be implemented as part of the sub-PSSCH mapping module 1008. In some aspects, the processor 1002 is configured to transmit via the transceiver 1010, to a UE, an indicator indicating a plurality of sub-PSSCHs within a slot.

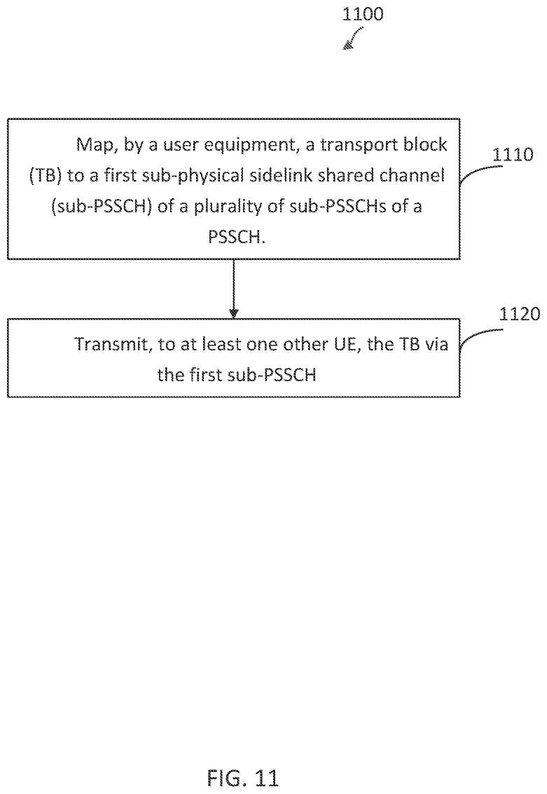

FIG. 11 is a flow diagram of a communication method 1100 according to some aspects of the present disclosure. Aspects of the method 1100 can be executed by a computing device (e.g., a processor, processing circuit, and/or other suitable component) of a wireless communication device or other suitable means for performing the steps. For example, a wireless communication device, such as the UE 115 or UE 900, may utilize one or more components, such as the processor 902, the memory 904, the sub-PSSCH mapping module 908, the transceiver 910, the modem 912, and the one or more antennas 916, to execute aspects of method 1100. The method 1100 may employ similar mechanisms as in the networks 100 and 200 and the methods described with respect to FIGS. 2-8. As illustrated, the method 1100 includes a number of enumerated steps, but the method 1100 may include additional steps before, after, and in between the enumerated steps. In some instances, one or more of the enumerated steps may be omitted or performed in a different order.

At 1110, the method 1100 of wireless communication performed by a UE (e.g., the UEs 115 and 900) includes mapping, by the UE, a transport block (TB) to a first sub-physical sidelink shared channel (sub-PSSCH) of a plurality of sub-PSSCHs of a PSSCH. In some aspects, the UE may map multiple TBs to multiple sub-PSSCHs within a slot. In some instances, each of the TBs mapped in a sub-PSSCH may be destined to a different UE over a sidelink channel. In this manner, the transmitting UE may increase the utilization of time/frequency resources within a single slot as compared to only transmitting to a single UE per slot. By partitioning the symbols and/or resource elements into multiple sub-PSSCHs within the slot, each sub-PSSCH may include a different TB destined to a different UE.

In some aspects, the UE may partition a PSSCH into a plurality of sub-PSSCHs. In some instances, the UE partitions the PSSCH such that each of the sub-PSSCHs is scheduled to occupy multiple symbols within the slot. For example, a slot may include 14 symbols. A sub-PSSCH may occupy 2, 3, 4, 5, 6, or more symbols. In some instances, each sub-PSSCH may occupy contiguous symbols within the slot. In this regard, each sub-PSSCH may occupy groups of symbols that are contiguous in time. The group of contiguous symbols may include any number of symbols contained within the slot. In some instances, the sub-PSSCHs may occupy symbol indexes 2, 3, and 4, symbol indexes 4, 5, and 6, symbol indexes, 7, 8, 9, 10, 11, and 12, and/or any other groups of contiguous symbols within the slot.

In some aspects, the UE may partition the PSSCH such that the sub-PSSCHs are partitioned across a resource element (RE) boundary. In this regard, each of the sub-PSSCHs may occupy multiple REs within the slot. A slot may include 14 symbols in the time domain. Each RE may include one subcarrier (e.g., 15 kHz, 30 kHz, 60 kHz, 120 kHz, etc.) in the frequency domain and one symbol in the time domain. Each sub-PSSCH may occupy groups of REs that are contiguous in frequency and/or time. Each group of REs may include a whole number of REs and not include any partial REs. Each sub-PSSCH may include any number of REs contained within the slot. The REs of adjacent PSSCHs may be contiguous. For example, a first sub-PSSCH may occupy all the REs in symbols 4, 5, and x REs in symbol 6. A second sub-PSSCH, adjacent to the first sub-PSSCH, may occupy the remaining resource elements in symbol 6 (total number of REs in symbol 6-x) and all the REs in symbols 7, 8, and 9. In the case where each symbol includes 12 consecutive REs with a 15 kHz subcarrier spacing, the first sub-PSSCH may occupy x REs, where x is a whole number, in symbol 6 and the second PSSCH may occupy 12-x consecutive REs. For example, the first sub-PSSCH may occupy 10 REs in symbol 6 covering 150 kHz and the second sub-PSSCH may occupy the remaining 2 REs covering 30 kHz.

In some aspects, the UE may transmit a sub-PSSCH that includes at least one demodulation reference signal (DMRS). A DMRS may be a reference signal used by the receiving UEs for channel estimation and compensating for Doppler effects at high UE speeds. The DMRS may be included in each sub-PSSCH. In this regard, the DMRS may be located anywhere within the sub-PSSCH. For example, the DMRS may be located in the first symbol of the sub-PSSCH, the last symbol of the sub-PSSCH, or any symbol of the sub-PSSCH. In some instances, the DMRS may include all REs within the symbol. In some aspects, the DMRS may include a portion of the REs within the symbol.

In some aspects, the UE may transmit a sub-PSSCH without a DMRS. In this regard, the UE may transmit certain sub-PSSCHs that include a DMRS and transmit certain other sub-PSSCHs that do not include a DMRS. A receiving UE may utilize a DMRS in order to properly estimate the channel and decode control information and data received in a TB. In this regard, a UE that receives a TB within a sub-PSSCH may use the DMRS of another sub-PSSCH in order to estimate the channel and decode the TB. For example, a transmitting UE may map a TB to a sub-PSSCH in symbols 7, 8, and 9 that is destined for a first receiving UE. The DMRS may be located in any symbol of the sub-PSSCH. In this example, the DMRS may be located in symbol 9. The transmitting UE may also map TB to a sub-PSSCH in symbols 10, 11, and 12 that is destined for a second receiving UE. Symbols 10, 11, and 12 may include a TB but not include a DMRS. The second receiving UE may receive the DMRS located in symbol 9 and perform channel estimation. The second receiving UE may receive the TB mapped to the sub-PSSCH in symbols 10, 11, and 12 and successfully decode the TB based on the channel estimation performed using the DMRS of symbol 9. In some aspects, a UE that uses a DMRS from a sub-PSSCH that is received earlier than the sub-PSSCH that includes the TB for the UE may decrease a coding and/or processing delay compared to using a DMRS in the sub-PSSCH that includes the TB for the UE.

In some aspects, the UE may map the TB to a sub-PSSCH based on a priority level associated with the TB. In this regard, the UE may determine a priority level of the TB based on the type of data to be transmitted (e.g., a safety message, sensor measurements, actuator controls, entertainment content, voice, text, authentication, financial data, etc.). In some aspects, the UE may determine the priority level based on categories of data defined in a standard (e.g., 3GPP standard, SAE standard, IEEE standard, etc.). In some aspects, the transmitting UE may not determine the priority level of the TB but may instead receive an indication of the priority level of the TB in a message from another node. For example, the UE may determine the priority level based on communication received from another node in the communications network (e.g., another UE, a BS, a server, a core network node, etc.). The UE may determine the priority level based on absolute values. The absolute values may be integer values based on categories of priority levels. For example, a priority level of one may be the highest priority level. In some aspects, the UE may determine the priority level based on relative priority levels between the TBs. For example, a first TB may have a lower priority level than a second TB, the second TB may have a lower priority level than a third TB, etc. The UE may map a TB having a high priority to a sub-PSSCH at a location earlier in the slot than a TB having a lower priority. Symbols having a lower index (e.g., 0, 1, 2, 3) occur earlier in time than symbols having a higher index (e.g., 10, 11, 12, 13). For example, the UE may map a TB having a high priority to a sub-PSSCH in symbols 1, 2, and 3, while mapping a TB having a lower priority to symbols 10, 11, and 12. The priority level of a TB may be associated with a latency requirement of the TB. A higher priority level may be associated with a lower latency requirement. In this regard, scheduling the TBs with higher priority sooner than the TBs with lower priority, the latency associated with delivery of the higher priority TBs may be reduced compared to the latency associated with delivery of the lower priority TBs.

In some aspects, the UE may map the TB to the sub-PSSCH based on a packet delay budget associated with the TB. In this regard, the UE may have knowledge of a packet delay budget and/or a latency budget associated with the TB. The packet delay budget may be a maximum time to transmit the TB to the receiving UE. The packet delay budget may be based on the type of data to be communicated and/or a UE-type of the receiving UE. For example, data related to safety applications associated with UEs performing vehicle-to-vehicle communications may have a lower packet delay budget compared to data related to personal messaging. As another example, data related to communications between robot controllers and sensors/actuators may have a lower packet delay budget compared to data related to content streaming. The UE may determine the packet delay budget associated with the TB based on a configuration received from another node in the communications network (e.g., the receiving UE, another UE a BS, a server, a core network node, etc.).

The UE may map a TB having a lower packet delay budget to a sub-PSSCH at a location earlier in the slot than a TB having a higher packet delay budget. Symbols having a lower index (e.g., 0, 1, 2, 3) occur earlier in time than symbols having a higher index (e.g., 10, 11, 12, 13). In this regard, the UE may map a TB having a lower packet delay budget to a sub-PSSCH in symbols 1, 2, and 3, while mapping a TB having a higher packet delay budget to symbols 10, 11, and 12. By scheduling the TBs with lower packet delay budget sooner than the TBs with higher packet delay budget, the latency associated with delivery of the TBs having a lower packet delay budget may be reduced compared to the latency associated with delivery of TBs having higher packet delay budget.

In some aspects, the UE may map at least one physical sidelink feedback channel (PSFCH) resource to each sub-PSSCH of the plurality of sub-PSSCHs. In this regard, the PSFCH resource(s) may be used to communicate sidelink feedback, such as hybrid automatic repeat request (HARQ) feedback (e.g., acknowledgement or negative acknowledgement (ACK/NACK) information), transmit power control (TPC), and/or a scheduling request (SR), for the associated sub-PSSCH. In some aspects, each sub-PSSCH within a slot may correspond to particular PSFCH resource(s). Having each sub-PSSCH with a corresponding PSFCH resource(s) may reduce latency for reporting sidelink feedback, which may further assist with enabling low latency communication and more efficient use of network resources. The UE may map each TB in a sub-PSSCH to Z physical resource blocks (PRBs) on the PSFCH. The Z PRBs may carry Z×Y PSFCH sequences for PSFCH feedback corresponding to the sub-PSSCH that is mapped to the Z PRBs. In this regard, the value of Y may be selected from a set of {1, 2, 3, 4, 6} that represents a number of cyclic shift pairs (e.g., a dimension in the code domain). When a UE transmits to a receiving UE via a particular sub-PSSCH, the receiving UE may determine one or more PRBs (e.g., Z PRBs) on the PSFCH that are mapped to the particular sub-PSSCH. The receiving UE may transmit HARQ feedback on the one or more PRBs. The transmitting UE may monitor the one or more PRBs for the HARQ feedback. Based at least in part on the HARQ feedback, the transmitting UE may determine whether to retransmit the TB that was transmitted in the particular sub-PSSCH.

In some aspects, the transmitting UE may indicate to a receiving UE the PSFCH resources associated with a sub-PSSCH. In some instances, the UE may transmit a second stage SCI (SCI-2) to the receiving UE. The SCI-2 may indicate one or more PSFCH resources for transmission of HARQ feedback (e.g., ACK/NACK feedback) associated with a corresponding sub-PSSCH. For example, the SCI-2 for a sub-PSSCH may indicate a K1 value that indicates an offset between the sub-PSSCH (e.g., a starting symbol of the sub-PSSCH or an ending symbol of the sub-PSSCH) and a corresponding PSFCH resource (e.g., a time domain resource) in which HARQ feedback, corresponding to the sub-PSSCH, is to be transmitted. In this regard, in some instances the offset may be indicated as a number of symbols to enable greater scheduling flexibility and reduced latency as compared to signaling a slot for the HARQ feedback. Additionally or alternatively, the SCI-2 may indicate a resource index for the PSFCH (e.g., a time domain resource index, a frequency domain resource index, and/or a PRB index).

At 1120, the method 1100 includes transmitting, to at least one other UE, the TB via the first sub-PSSCH. In some aspects, the UE may transmit different TBs to different UEs using sub-PSSCHs in a slot. In this regard, the UE may increase the utilization of resources in the slot and reduce transmission latency compared to transmitting a single TB to a single UE in the slot.

In some aspects, the UE may transmit padding in one or more sub-PSSCHs of the plurality of sub-PSSCHs. In this regard, when the UE transmits a TB in one or more sub-PSSCHs within a slot, but in fewer than all of the sub-PSSCHs within the slot, then the UE may transmit padding in the empty sub-PSSCHs. An “empty sub-PSSCH” may include a sub-PSSCH that is not scheduled for a data transmission and/or a sub-PSSCH that does not carry a TB. For example, when a UE partitions a slot into 4 sub-PSSCHs, the UE may map TB s into the first and fourth sub-PSSCHs while the second and third sub-PSSCHs are not scheduled to carry a TB. In this scenario, the transmitting UE would not normally transmit in the second and third sub-PSSCHs. However, if the UE transmits in only a subset of the sub-PSSCHs of the slot, then this sub-PSSCH mapping may cause power transmission variation and disrupt proper reception of the sub-PSSCHs by the receiving UE. To reduce power variation, the UE may transmit padding in the second and third sub-PSSCHs. In some aspects, the padding may include a reference signal, which may be used to improve data reception. Additionally or alternatively, the padding within a sub-PSSCH may include a repetition of the first or fourth sub-PSSCH. By retransmitting TBs in the empty sub-PSSCHs, the likelihood of successful reception of the TB may be improved.

In some aspects, the UE may transmit padding in all empty sub-PSSCHs within a slot if the UE transmits in any sub-PSSCHs in the slot, thereby reducing power variation. In some instances, the UE may map the same TB to two or more sub-PSSCHs. In some aspects, the UE may combine a TB with one or more of the empty sub-PSSCHs in the slot. For example, if a slot includes 4 PSSCHs and the UE has only two TBs to transmit, the UE may map the first TB to the first sub-PSSCH and map the second TB to the second, third, and fourth sub-PSSCHs. The UE may rate match the second TB with the second, third, and fourth sub-PSSCHs. Additionally or alternatively, the UE may distribute the scheduled TBs over the sub-PSSCHs. For example, a slot may include four sub-PSSCHs. The UE may have two TBs scheduled for transmission. The UE may map and rate match the first TB to the first two sub-PSSCHs. The UE may also map and rate match the second TB to the last two sub-PSSCHs.

In some aspects, the UE may transmit first-stage sidelink control information (SCI-1) to one or more receiving UEs indicating the plurality of sub-PSSCHs are enabled or disabled for the slot. In this regard, the UE may transmit the SCI-1 over a PSCCH. The UE may transmit an SCI-1 that indicates a sub-PSSCH configuration in the time and/or frequency domain for the multiple sub-PSSCHs. The UE may transmit a PSCCH communication that includes SCI-1 control information applicable to all of the sub-PSSCHs in the slot. Additionally or alternatively, the UE may transmit a PSCCH communication that includes SCI-1 control information applicable to one or more sub-PSSCHs and/or a subset of the sub-PSSCHs in the slot. The UE may transmit an SCI-1 that indicates a common modulation and coding scheme for all sub-PSSCHs in the slot.

In some aspects, the UE may transmit a combined second-stage sidelink control information (SCI-2) including sidelink control information for each of the sub-PSSCHs of the plurality of sub-PSSCHs. In this regard, the UE may transmit the SCI-2 in the first sub-PSSCH of the plurality of sub-PSSCHs. The combined SCI-2 may override a common modulation and coding scheme in the SCI-1 for the sub-PSSCHs with a per-sub-PSSCH modulation and coding scheme indicated in the combined SCI-2. The UE may transmit the SCI-1 including an indicator that indicates one or more values of a rate matching parameter for the combined SCI-2 corresponding to the plurality of sub-PSSCHs within the slot. In some aspects, the UE may transmit the combined SCI-2 as a concatenation of SCI-2s for each of the sub-PSSCHs. In this regard, the SCI-2 may include a common field for the source ID. The SCI-2 may include a concatenation of SCI-2 fields for each sub-PSSCH in which each SCI-2 field includes a HARQ ID, NDI, RV, destination ID, CSI request, MCS, PFSCH resource indication including the K1 offset to the associated PSFCH resource, the PSFCH resource index, and the parameters associated with the PSFCH resource hashing.

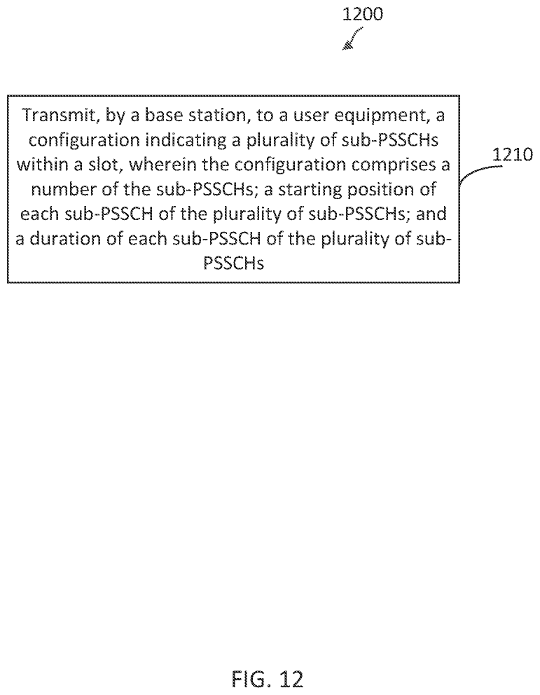

FIG. 12 is a flow diagram of a communication method 1200 performed by a BS according to some aspects of the present disclosure. Steps of the method 1200 can be executed by a computing device (e.g., a processor, processing circuit, and/or other suitable component) of a communication device or other suitable means for performing the steps. For example, a communication device, such as the BS 105 or the BS 1000, may utilize one or more components, such as a processor 1002, a memory 1004, instructions 1006, a sub-PSSCH mapping module 1008, a transceiver 1010, a modem 1012, an RF unit 1014, and one or more antennas 1016 to execute the steps of method 1200. The method 1200 may employ similar mechanisms as in the networks 100 and 200 and the methods described with respect to FIGS. 2-8. As illustrated, the method 1200 includes a number of enumerated steps, but the method 1200 may include additional steps before, after, and in between the enumerated steps. In some instances, one or more of the enumerated steps may be omitted or performed in a different order.

At step 1210, the method 1200 of wireless communication performed by a BS (e.g., the BSs 105 and 1000) includes transmitting, to a user equipment (UE), a configuration indicating a plurality of sub-PSSCHs within a slot, wherein the configuration comprises a number of the sub-PSSCHs, a starting position of each sub-PSSCH of the plurality of sub-PSSCHs, and a duration of each sub-PSSCH of the plurality of sub-PSSCHs. In this regard, the BS may transmit the configuration in an RRC configuration message, an RRC re-configuration message, and/or MAC control element signaling. The BS may transmit the configuration via a physical downlink shared channel (PDSCH), physical downlink control channel (PDCCH), or other suitable channel. The BS may transmit the configuration as a semi-static configuration or on a dynamic basis. The configuration transmitted by the BS at 1210 may indicate whether sub-PSSCH partitioning in a slot is enabled or disabled. The configuration transmitted by the BS at 1210 may indicate the number of sub-PSSCHs in the slot. configuration transmitted by the BS at 1210 may indicate the starting position of each sub-PSSCH as a symbol index or a resource element index. In some aspect, the configuration transmitted by the BS at 1210 may indicate the number of symbols and/or the number of resource elements in each of the sub-PSSCHs. The configuration transmitted by the BS at 1210 may be received by a UE and used by the UE to partition a slot into sub-PSSCHs, map the TBs to the sub-PSSCHs, configure the SCI-1, and/or configure the SCI-2.

By way of non-limiting examples, the following aspects are included in the present disclosure.

Aspect 1 includes a method of wireless communication performed by a user equipment (UE), the method comprising mapping a transport block (TB) to a first sub-physical sidelink shared channel (sub-PSSCH) of a plurality of sub-PSSCHs of a PSSCH; and transmitting, to at least one other UE, the TB via the first sub-PSSCH.

Aspect 2 includes the method of aspect 1, wherein each sub-PSSCH of the plurality of sub-PSSCHs is scheduled in contiguous symbols within a slot.

Aspect 3 includes the method of any of aspects 1-2, wherein each sub-PSSCH of the plurality of sub-PSSCHs is fully contained within a slot.

Aspect 4 includes the method of any of aspects 1-3, wherein at least one sub-PSSCH of the plurality of sub-PSSCHs is partitioned across a resource element boundary.

Aspect 5 includes the method of any of aspects 1-4, wherein each sub-PSSCH of the plurality of sub-PSSCHs comprises at least one demodulation reference signal.

Aspect 6 includes the method of any of aspects 1-5, wherein at least one sub-PSSCH of the plurality of sub-PSSCHs does not include a demodulation reference signal.

Aspect 7 includes the method of any of aspects 1-6, further comprising transmitting, to the at least one other UE, a demodulation reference signal via a second sub-PSSCH of the plurality of sub-PSSCHs.

Aspect 8 includes the method of any of aspects 1-7, wherein the transmitting the TB via the first sub-PSSCH comprises transmitting the TB to a first UE; and further comprising mapping a second TB to a second sub-PSSCH of the plurality of sub-PSSCHs of the PSSCH; and transmitting, to a second UE different than the first UE, the second TB via the second sub-PSSCH.

Aspect 9 includes the method of any of aspects 1-8, wherein the mapping the TB to the first sub-PSSCH is based on a priority level associated with the TB.

Aspect 10 includes the method of any of aspects 1-9, wherein the mapping the TB to the first sub-PSSCH is based on a packet delay budget associated with the TB.

Aspect 11 includes the method of any of aspects 1-10, further comprising transmitting padding in one or more sub-PSSCHs of the plurality of sub-PSSCHs.

Aspect 12 includes the method of any of aspects 1-11, further comprising rate matching the first sub-PSSCH and a second sub-PSSCH of the plurality of sub-PSSCHs, wherein the transmitting the TB via the first sub-PSSCH comprises transmitting the TB via the first sub-PSSCH and the second sub-PSSCH.

Aspect 13 includes the method of any of aspects 1-12, further comprising transmitting the TB in a second sub-PSSCHs of the plurality of sub-PSSCHs.

Aspect 14 includes the method of any of aspects 1-13, further comprising transmitting first-stage sidelink control information indicating the plurality of sub-PSSCHs are enabled.

Aspect 15 includes the method of any of aspects 1-14, further comprising transmitting combined second-stage sidelink control information including sidelink control information for each of the sub-PSSCHs of the plurality of sub-PSSCHs.

Aspect 16 includes the method of any of aspects 1-15, wherein the combined second-stage sidelink control information comprises a concatenation of second-stage sidelink control information for each of the sub-PSSCHs.

Aspect 17 includes the method of any of aspects 1-16, wherein the transmitting the combined second-stage sidelink control information comprises transmitting the combined second-stage sidelink control information in the first sub-PSSCH.

Aspect 18 includes the method of any of aspects 1-17, further comprising mapping at least one physical sidelink feedback channel resource to each sub-PSSCH of the plurality of sub-PSSCHs.

Aspect 19 includes a method of wireless communication performed by a base station (BS), the method comprising transmitting, to a user equipment, a configuration indicating a plurality of sub-PSSCHs within a slot, wherein the configuration comprises a number of the sub-PSSCHs; a starting position of each sub-PSSCH of the plurality of sub-PSSCHs; and a duration of each sub-PSSCH of the plurality of sub-PSSCHs.

Aspect 20 includes the method of aspect 19, wherein the starting position of each sub-PSSCH comprises a symbol index; and the duration of each sub-PSSCH comprises a number of symbols.

Aspect 21 includes the method of any of aspects 19-20, wherein the starting position of each sub-PSSCH comprises a resource element index; and the duration of each sub-PSSCH comprises a number of resource elements.

Aspect 22 includes a user equipment (UE) comprising a transceiver, a memory, and a processor coupled to the transceiver and the memory, the UE configured to perform any one of aspects 1-18.

Aspect 23 includes a base station (BS) comprising a transceiver, a memory, and a processor coupled to the transceiver and the memory, the BS configured to perform any one of aspects 19-21.

Aspect 24 includes a non-transitory computer-readable medium storing one or more instructions for wireless communication, the one or more instructions comprising one or more instructions that, when executed by one or more processors of a user equipment, cause the one or more processors to perform any one of aspects 1-18.

Aspect 25 includes a non-transitory computer-readable medium storing one or more instructions for wireless communication, the one or more instructions comprising one or more instructions that, when executed by one or more processors of a base station, cause the one or more processors to perform any one of aspects 19-21.

Aspect 26 includes a user equipment (UE) comprising means to perform any one of aspects 1-18.

Aspect 27 includes a base station (BS) comprising means to perform any one of aspects 19-21.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

What is claimed is:

1. A method of wireless communication performed by a user equipment (UE), the method comprising:
mapping a transport block (TB) to a first sub-physical sidelink shared channel (sub-PSSCH) of a plurality of sub-PSSCHs of a PSSCH; and
transmitting, to at least one other UE, the TB via the first sub-PSSCH.

2. The method of claim 1, wherein each sub-PSSCH of the plurality of sub-PSSCHs is scheduled in contiguous symbols within a slot.

3. The method of claim 1, wherein each sub-PSSCH of the plurality of sub-PSSCHs is fully contained within a slot.

4. The method of claim 1, wherein at least one sub-PSSCH of the plurality of sub-PSSCHs is partitioned across a resource element boundary.

5. The method of claim 1, wherein each sub-PSSCH of the plurality of sub-PSSCHs comprises at least one demodulation reference signal.

6. The method of claim 1, wherein at least one sub-PSSCH of the plurality of sub-PSSCHs does not include a demodulation reference signal.

7. The method of claim 1, further comprising:
transmitting, to the at least one other UE, a demodulation reference signal via a second sub-PSSCH of the plurality of sub-PSSCHs.

8. The method of claim 1, wherein the transmitting the TB via the first sub-PSSCH comprises transmitting the TB to a first UE; and
further comprising:
mapping a second TB to a second sub-PSSCH of the plurality of sub-PSSCHs of the PSSCH; and
transmitting, to a second UE different than the first UE, the second TB via the second sub-PSSCH.

9. The method of claim 1, wherein the mapping the TB to the first sub-PSSCH is based on a priority level associated with the TB.

10. The method of claim 1, wherein the mapping the TB to the first sub-PSSCH is based on a packet delay budget associated with the TB.

11. The method of claim 1, further comprising:
transmitting padding in one or more sub-PSSCHs of the plurality of sub-PSSCHs.

12. The method of claim 1, further comprising:
rate matching the first sub-PSSCH and a second sub-PSSCH of the plurality of sub-PSSCHs, wherein the transmitting the TB via the first sub-PSSCH comprises transmitting the TB via the first sub-PSSCH and the second sub-PSSCH.

13. The method of claim 1, further comprising:
transmitting the TB in a second sub-PSSCHs of the plurality of sub-PSSCHs.

14. The method of claim 1, further comprising:
transmitting first-stage sidelink control information indicating the plurality of sub-PSSCHs are enabled.

15. The method of claim 1, further comprising:
transmitting combined second-stage sidelink control information including sidelink control information for each of the sub-PSSCHs of the plurality of sub-PSSCHs.

16. The method of claim 15, wherein the combined second-stage sidelink control information comprises a concatenation of second-stage sidelink control information for each of the sub-PSSCHs.

17. The method of claim 15, wherein the transmitting the combined second-stage sidelink control information comprises:
transmitting the combined second-stage sidelink control information in the first sub-PSSCH.

18. The method of claim 1, further comprising:
mapping at least one physical sidelink feedback channel resource to each sub-PSSCH of the plurality of sub-PSSCHs.

19. A method of wireless communication performed by a base station (BS), the method comprising:
transmitting, to a user equipment, a configuration indicating a plurality of sub-PSSCHs within a slot, wherein the configuration comprises:
a number of the sub-PSSCHs;
a starting position of each sub-PSSCH of the plurality of sub-PSSCHs; and
a duration of each sub-PSSCH of the plurality of sub-PSSCHs.

20. The method of claim 19, wherein:
the starting position of each sub-PSSCH comprises a symbol index; and
the duration of each sub-PSSCH comprises a number of symbols.

21. The method of claim 19, wherein:
the starting position of each sub-PSSCH comprises a resource element index; and
the duration of each sub-PSSCH comprises a number of resource elements.

22. A user equipment (UE) comprising:
a transceiver, a memory, and a processor coupled to the transceiver and the memory, the UE configured to:
map a transport block (TB) to a first sub-physical sidelink shared channel (sub-PSSCH) of a plurality of sub-PSSCHs of a PSSCH; and
transmit, to at least one other UE, the TB via the first sub-PSSCH.

23. The UE of claim 22, wherein each sub-PSSCH of the plurality of sub-PSSCHs is at least one of:
scheduled in contiguous symbols within a slot;
fully contained within a slot; or
partitioned across a resource element boundary.

24. The UE of claim 22, wherein the UE is further configured to at least one of:
transmit, to the at least one other UE, a demodulation reference signal via a second sub-PSSCH of the plurality of sub-PSSCHs;
transmit padding in one or more sub-PSSCHs of the plurality of sub-PSSCHs;
transmit the TB in a second sub-PSSCHs of the plurality of sub-PSSCHs;
transmit first-stage sidelink control information indicating the plurality of sub-PSSCHs are enabled; or
transmit combined second-stage sidelink control information including sidelink control information for each of the sub-PSSCHs of the plurality of sub-PSSCHs.

25. The UE of claim 22, wherein the UE is further configured to:
transmit the TB to a first UE;
map a second TB to a second sub-PSSCH of the plurality of sub-PSSCHs of the PSSCH; and
transmit, to a second UE different than the first UE, the second TB via the second sub-PSSCH.

26. The UE of claim 22, wherein the UE is further configured to:
map the TB to the first sub-PSSCH based on at least one of:
a priority level associated with the TB; or
a packet delay budget associated with the TB.

27. The UE of claim 22, wherein the UE is further configured to:
rate match the first sub-PSSCH and a second sub-PSSCH of the plurality of sub-PSSCHs; and
transmit the TB via the first sub-PSSCH and the second sub-PSSCH.

28. The UE of claim 22, wherein the UE is further configured to:
map at least one physical sidelink feedback channel resource to each sub-PSSCH of the plurality of sub-PSSCHs.

29. A base station (BS) comprising:
a transceiver, a memory, and a processor coupled to the transceiver and the memory, the BS configured to:
transmit, to a user equipment, a configuration indicating a plurality of sub-PSSCHs within a slot, wherein the configuration comprises:
a number of the sub-PSSCHs;
a starting position of each sub-PSSCH of the plurality of sub-PSSCHs; and
a duration of each sub-PSSCH of the plurality of sub-PSSCHs.

30. The BS of claim 29, wherein:
the starting position of each sub-PSSCH comprises a symbol index or a resource element index; and
the duration of each sub-PSSCH comprises a number of symbols or a number of resource elements.
